(19) United States
(12) Patent Application Publication
(10) Pub. No.: US 2016/0144865 A1
(43) Pub. Date: May 26, 2016

(54) CONTROL DEVICE AND METHOD FOR OPERATING A CONTROL DEVICE OF A MOTOR VEHICLE

(71) Applicant: AUDI AG, Ingolstadt (DE)

(72) Inventor: MICHAEL STADLER, Arnsberg (DE)

(73) Assignee: Audi AG, 85045 Ingolstadt (DE)

(21) Appl. No.: 14/901,354

(22) PCT Filed: Jun. 23, 2014
(86) PCT No.: PCT/EP2014/001699

§ 371 Date: Dec. 28, 2015

(30) Foreign Application Priority Data
Jun. 29, 2013 (DE) 10 2013 010 930.2

(51) Int. Cl. B60W 40/09

(52) U.S. Cl. CPC B60W 40/09; B60W 2540/28; B60W 2540/30; B60W 2600/00

(57) ABSTRACT

A control device and a method for operating a control device of a motor vehicle by means of a driver profile of a driver of a motor vehicle are disclosed, wherein the driver profile can be created according to the driving behavior of the driver and is designed to be stored in a temporary storage means and transferred to a storage unit belonging to or associated with a control device of a motor vehicle, the driver profile of the motor vehicle containing operating data relating to parameters of at least one functional group characterizing or influencing the driving dynamics of the motor vehicle, by means of which parameters the driving behavior in the motor vehicle can be adjusted.

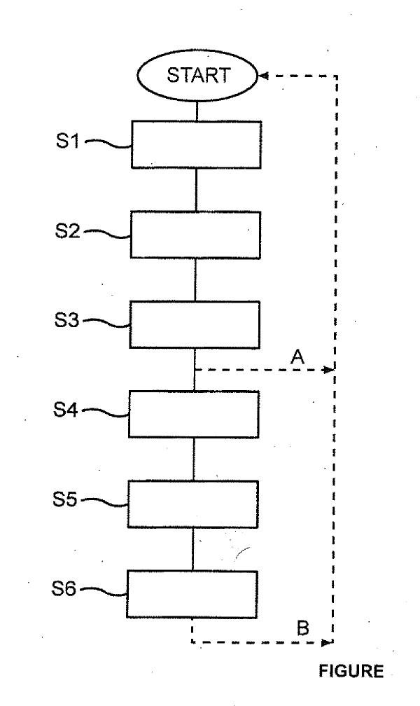

The invention relates to a method for operating a control device of a motor vehicle and a control device for operating the method.

Methods and devices, which enable a detection, analysis and management of operating data values, in particular motor speed, motor load, braking force, gas reception and the like, during operation of the motor vehicle, have been known for a long time. These operating data allow drawing conclusions regarding a state of a motor vehicle and in addition also enable deducing recommendations for measures, for example inspections, replacement of replacement parts etc.

Up to now the driver was only able to draw conclusions regarding his driving behavior by using fuel consumption, running performance and/or frequency of repairs of the motor vehicle as indicators.

More recent processing devices for operating data for motor vehicles enable to systematically detect, analyze and manage the motor vehicle operating data. Thus the owner of the vehicle can be comprehensively informed regarding the state of the motor vehicle and from this can deduce required steps for maintaining the driving performance of his motor vehicle.

The printed publication DE 198 12 318 A1 discloses a generic control device with an electronic logbook integrated in a dashboard processor of a motor vehicle, which triggers predetermined measures or action programs in dependence on operating data. In the logbook items of information relating to the motor vehicle and/or a driver are gathered and can be provided at a central site for the driver, owner, repair shop etc. In addition a fast access to the operating data can be realized and a forgery proof access limitation is ensured. Finally the dashboard processor enables generating driver profiles by way of associated operating data. With these driver profiles certain instructions to the driver or the vehicle can be associated, for example learning programs for rational driving regarding fuel consumption and material wear. In addition the opposite route is provided, i.e., the adaption of the vehicle to the driver profile, wherein certain suspension settings, transmission ratios, throttle functions etc. are controlled. However, the determined data or the driver profile, which represents a driving behavior of the driver is exclusively used in the motor vehicle itself.

It is an object of the invention to provide a control device and a method for operating a control device of a motor vehicle by means of a driver profile, which enables a flexible and simple use of the driver profile.

The object is solved according to the invention by a method for operating a control device of a motor vehicle according to claim 1. The method for operating the control device of the motor vehicle by means of a driver profile includes the following steps, wherein:
measured operating data of parameters of at least one functional group which characterizes or influences a driving dynamic of a first motor vehicle are recorded by an operating data recording device;
the recorded operating data are converted by means of an operating data processing device into a specific driver profile of the motor vehicle;
the driver profile of the motor vehicle is provided via an interface for display;
the driver profile is stored in a temporary memory;
the driver profile is transmitted from the temporary memory into a memory device of a control device of a motor vehicle;
and is used by the control device for pre adjusting of at least one functional group which characterizes or influences a driving dynamic of the motor vehicle.

By providing a step of temporarily storing the generated driver profile, it is possible to flexibly use the driver profile. Thus the driver profile can be used for maintenance of the motor vehicle or adjustment of the motor vehicle to the driver profile or to the driving behavior of the driver. In addition the adjustment of a motor vehicle to the driving behavior of the driver is also possible for motor vehicles that the driver so far has not yet driven. Such a driver profile can for example be transmitted along with the order for purchasing a vehicle. This is in particular advantageous when intelligent control devices adjust a response characteristics or driving behavior of the motor vehicle to the specific driver by way of a longer learning period. By transmitting the driver profile to the “new” motor vehicle, a lengthy learning phase can be bridged in a simple manner.

In an advantageous embodiment of the invention, the recoding of the operating data of the parameters, the convertation of the operating data into a specific driver profile is performed continuously in predetermined time intervals. A continuous adjustment of the driver profile to the driving behavior of the driver ensures that an average recording of operating data of the parameters, or respectively a recording of operating data that is independent of extraordinary deviations of the driving behavior, is performed, which serve for forming the driver profile.

The driver profile can be used particularly flexibly when the driver profile is transmitted into a memory device, which is belongs to or is assigned to the control device. The memory device, which belongs to the control device, can be a memory device, which is integrated in the control device, while in addition or alternatively the driver profile can also be transmitted to a memory device which is externally assigned to the control device. This enables performing a remote diagnosis or adjustment of the motor vehicle simultaneously in the vehicle and also outside the vehicle, for example in a repair shop or at the vehicle manufacturer. For this an appropriate digital connection is required for the transmission of the driver profile to a memory device assigned to the control device. This can be accomplished via a cable-based connection or wirelessly. This also allows performing a relatively realistic representation of the driving behavior of the driver under real time conditions.

In a particularly preferred embodiment of the invention the driver profile is transmitted from the intermediate memory into a memory device of the control device of the same or another same type vehicle. Thus the data can also be used in the case the control device which autonomously learns (for example by neuronal networks) is defective and has to be replaced in order to place the driver behavior/response behavior of the vehicle to the new control device again, without having to start a “new” learning phase. A transmission to a structurally identical motor vehicle occurs in an analogous manner, which this also allows bridging the learning phase.

In addition the data of the driver profile can also be used to offer or recommend to the same driver a different motor variant/transmission variant, which is “better” for the driver, for example in order to enable a lower fuel consumption or to account for specific demands of the deriver regarding a sporty behavior etc.

Thus in a further embodiment of the invention, when transmitting the driver profile into the control device of a motor vehicle of a different type, the driver profile can be adjusted by means of at least one correction factor. This enables an even more flexible use of the driver profile and allows an adjustment or tuning of a new vehicle of the respective driver even more easily.

In order to be able to particularly effectively perform an adjustment when transmitting the driver profile into a control device of a motor vehicle of a different type, the correction factor includes, for adjusting the driver profile of the second motor vehicle, a parameter for a difference of the center of gravity and/or a difference in weight and/or spatial dimensions of the two vehicles—of the vehicle from which the driver profile originates and the new motor vehicle of the type which differs from that of the original vehicle.

A further aspect of the invention relates to a control device of a motor vehicle according to claim 7. The control device of the motor vehicle includes:
an operating detection device for recording measured operating data of parameters of at least one functional group which characterizes or influences a driving dynamic of the motor vehicle;
an operating data processing device for converting the recorded operating data of the parameters into a specific driver profile;
a memory device configured to store a driver profile, in order to perform a pre adjustment of at least one functional group which characterizes or influences a driving dynamic of the motor vehicle,
wherein the control device has an interface for outputting or inputting the driver profile.

In order to enable a flexible use of the specific driver profile, the memory device of the driver profile is configured as a memory device, which belongs—or as an alternative—which is assigned to the control device.

The above advantages and embodiments which result form the method for operating such a control device also apply to the control device itself or are equivalent thereto.

In a particularly advantageous embodiment of the control device the functional groups are a braking system and/or a transmission and/or a chassis and/or an aerodynamics device and/or a steering and/or a throttle response and/or a gear shift of a motor vehicle. The individual functional groups enable a differentiated and driver-oriented adjustment or tuning. This enables to particularly easily determine, analyze and manage user-specific or driver-specific data.

In the following the invention and exemplary embodiments are explained in more detail by way of a drawing. Hereby the sole FIGURE shows by way of a flow chart the individual method steps for operating a control device of a motor vehicle by means of a driver profile according to a preferred embodiment of the invention.

The flow chart of the FIGURE illustrates the essential steps of the method for operating a control device of a motor vehicle, which enable generating a driver profile, which can subsequently transmitted to a vehicle of the same or a different type. As soon as the driver of the respective vehicle starts the vehicle START, operating data are recorded continuously in predetermined time intervals.

Hereby in a first step S1 operating data of parameters of at least one functional group, which characterizes or influences a driving dynamic of a first motor vehicle, are recorded by an operating data detection device. By way of sensors parameters for example for motor speed gradient, motor speed level, acceleration, speed, gear shift frequency, gear ranges and steering behavior and the like are determined.

In a subsequent step S2 the recorded operating data are converted into a specific driver profile of the motor vehicle by means of an operating data processing device. The operating data processing device can be a conventional processor, which is either dedicated or is installed as part of a combined circuit in the control device of the motor vehicle. The specific driver profile is subsequently in a step S3 provide via an interface for output, for where the driver profile in a further step S4 can be stored in a temporary memory.

Hereby the recording of the operating data of the parameter, the convertation of the operating data into the specific driver profile is performed continuously in predetermined time intervals. This ensures that the specific driver profile is based on an “average” driving behavior of the driver. As a result of the continuous determination of the driver profile, the driver profile is adjusted in predetermined time intervals. A dashed line A indicates an iteration step of the continuous recording in predetermined time intervals of the parameters—step S1—the convertation of the operating parameters into the specific driver profile and—step S2—the provision of the driver profile—step S3—by the control device. The manner in which this is performed, for example by a weighting of different operating data of parameters, is not described here. It is only noted that stochastic models or probability theory models can be used for generating the driver profile.

The temporary memory for the driver profile can be a memory device which is integrated in the control device of the motor vehicle, as well as a memory device which is arranged independent of the motor vehicle, for example a mobile data carrier or databases of a certain vehicle manufacturer or a car repair shop. In a preferred embodiment “temporary” driver profiles are transmitted from a memory device belonging to the control device to an external memory device assigned to the control device. In this way it is possible to generate a backup of the driver profile.

In a further step S5, the temporarily stored driver profile is now transmitted from the temporary memory to a memory device of a control device of the motor vehicle. The control device of the motor vehicle can be the control device of the same vehicle or that of another vehicle. In the case of the same vehicle, a control device that had to be replaced due to a defect can again be operated with the meanwhile temporarily stored driver profile. This allows bridging a new learning phase of an autonomously learning control device,—for example by means of a neuronal network—and as a result the motor vehicle can be again adjusted to the specific driver and his driving style.

A dashed line B indicates the path of the transmission of the generated and temporarily stored driver profile to/into a “new” control device of a motor vehicle.

According to another option, the temporarily stored driver profile can be transmitted to a motor vehicle of the same type. In a particularly preferred embodiment of the invention, the driver profile can be adjusted by means of a correction factor also for a transmission of the driver profile to a control device of a vehicle of a different type. For this the correction factor for adjusting the driver profile of the second motor vehicle is adjusted by means of parameters for the difference of center of gravity, difference of weight, difference of spatial dimensions of the new vehicle compared to the original vehicle from which the driver profile originates.

In a further step S6, a pre-adjustment of at least one functional group, which characterizes or influences a driving dynamic of the motor vehicle, can be used with the established driver profile. In other words this means that depending on the equipment of the “new” motor vehicle one or multiple functional groups can be influenced. Consequently, specific functional groups, for example the spring-damper setting of the chassis of the motor vehicle and/or a throttle response and/or gear shift of the motor vehicle are pre-set, while the brake system and/or the steering are trained anew based on the driving of the driver. This enables easily and flexibly influencing the adjustment of the motor vehicle and thereby optimizing the driving to the specific driver—regarding fuel consumption, driving dynamic etc. of the individual specific driver.

In a further her not shown embodiment of the invention multiple driver profiles are generated for the same vehicle. For this it is only required that the driver of the motor vehicle identifies himself to the control device, in order to be assigned the correct driver profile, This ensures a fast access to the operating data and at the same time enables secure access by limiting access.

The features or feature combinations described in the above specification or description of the Figures, may not only be used in the stated combination but also in different combinations without departing from the scope of the invention. Thus the invention also covers and discloses embodiments, which are not explicitly shown and explained in the FIGURE, which however, can be generated by separate feature combinations based on the explained embodiments.

What is claimed is:

1-9. (canceled)

10. A method for operating a control device of a motor vehicle by means of a driver profile, comprising:
recording with an operating data recording device measured operating data of parameters of at least one functional group of the motor vehicle, which characterizes or influences a driving dynamic of a first motor vehicle;
converting the recorded operating data by an operating data processing device into a specific driver profile of the motor vehicle;
providing the driver profile of the first motor vehicle via an interface for display;
storing the driver profile in a temporary memory;
transmitting the driver profile from the temporary memory into a memory device of a control device of the first or a second motor vehicle; and
using the driver profile by the control device for pre-adjusting at least one functional group, which characterizes or influences a driving dynamic of the first or the other motor vehicle.

11. The method of claim 10, wherein the recording of the operating data of the parameters and the converting of the operating data into the specific-driver profile is performed continuously in predetermined time intervals.

12. The method of claim 10, wherein the driver profile is transmitted into a memory device belonging to or assigned to the control device.

13. The method of claim 10, wherein the driver profile is transmitted from the temporary memory into a memory device of the control device of the first motor vehicle or the second motor vehicle constructively identical to the first motor vehicle.

14. The method of claim 10, wherein the second motor vehicle is of a different type than the first motor vehicle, said method further comprising during the transmission of the driver profile into the control device of the second motor vehicle, adjusting the driver profile by means of at least one correction factor.

15. The method of claim 14, wherein the correction factor for adjusting the driver profile of the other motor vehicle includes a parameter for a difference of a center of gravity, a difference in weight and/or spatial dimensions between the first and the second motor vehicle.

16. A control device for a motor vehicle, comprising:
an operating data recording device configured for recording measured operating data of parameters of at least one functional group of the motor vehicle which characterizes or influences a driving dynamic of the motor vehicle;
an operating data processing device configured for converting the recorded operating data of the parameters into a specific driver profile;
a memory device configured to store a driver profile, in order to perform a pre-adjustment of at least one functional group of the motor vehicle which characterizes or influences a driving dynamic of the motor vehicle, wherein the control device has an interface for outputting or inputting the driver profile.

17. The control device of claim 16, wherein the memory device for storing the driver profile is a part of or is assigned to the control device.

18. The control device of claim 16, wherein the at least one functional group comprises at least one member selected from the group consisting of a brake system, a transmission, a chassis, an aerodynamics device, a steering, a throttle response and a gear shift of a motor vehicle.
